(19) United States
(12) Patent Application Publication
(10) Pub. No.: US 2009/0058667 A1
(43) Pub. Date: Mar. 5, 2009

(54) TIRE PRESSURE MONITORING SYSTEM SENSOR PATCH

(76) Inventors: Bryn James Dixon, Milton Keynes (GB); Paul Vickery, Towcester (GB)

Correspondence Address: KEUSEY, TUTUNJIAN & BITETTO, P.C., 20 CROSSWAYS PARK NORTH, SUITE 210, WOODBURY, NY, 11797, US

(21) Appl. No.: 12/268,148

(22) Filed: Nov. 10, 2008

(30) Foreign Application Priority Data
Sep. 24, 2008 (GB) GB0817511.9

(51) Int. Cl. B60C 23/02

(52) U.S. Cl. 340/626

(57) ABSTRACT

A sensor mounting assembly for securing a sensor within a pressurized chamber defined between a wheel and a tire, comprises a patch 2 having a fastening surface 2a by a device in which it is securable, in use, to an inner surface of a tire or wheel. A plate 5 having a threaded aperture 4 is embedded in the patch 2. A sensor housing 1 has a threaded shaft 3 extending from it which complements the thread formed in the plate 5, so that the shaft 3 may be screwed into the aperture 4 in order to secure said housing to the exterior of the patch.

### BACKGROUND OF THE INVENTION

1. Field of the Invention

The present invention relates to systems for mounting tire pressure sensors within a wheel to monitor the pressure within the tire, and more particularly to patch mounting systems in which the sensor is attached within the pressurized cavity by means of a patch.

2. The Prior Art

A number of different systems are known for attaching a tire pressure monitoring sensor arrangement to the inner surface of a tire in order to enable the environment within the tire chamber, in particular temperature and pressure, to be monitored. One known approach is to utilize a patch, in particular a rubber patch, having a flat flexible surface which carries an adhesive by means of which the patch can be secured to a surface of the tire. The flexibility of the patch enables it easily to be attached to a curved inner surface of the tire. One known approach is to embed the sensor within the patch so it is an integral part thereof. It is also known to form a pocket within the patch in which the sensor is removably insertable, as well as to form a post which stands substantially upright from the surface of the patch remote from the adhesive carrying fastening surface, the sensor being secured to the top of said post so as to be decoupled from the stress field within the patch, in particular when it is contoured against the curved inner surface of a tire.

### SUMMARY OF THE INVENTION

According to the present invention there is provided a sensor mounting assembly for securing a sensor within a pressurized chamber defined between a wheel and a tire, comprising a patch having a fastening surface by means of which it is securable, in use, to an inner surface of a tire or wheel and a first part of a two part complementary fixing system embedded in the patch, and a sensor housing having a second part of the two part complement fixing system provided thereon, said first and second parts of the complementary fixing system being engageable together in order to secure said housing to the exterior of the patch.

A sensor mounting assembly in accordance with the invention has the advantage that the housing may easily be fastened to the patch in a removable manner, enabling replacement of the sensor without requiring a new patch.

In one embodiment, the two part fixing system comprises a threaded shaft which mates with a complementary threaded recess. The threaded recess may be in the form of plate, such as a metal hexagonal part having a threaded aperture passing therethrough, which is embedded in the patch, in particular molded as an integral part of the patch. The threaded shaft is then formed as a projection on the sensor housing and screws into the threaded recess from the side of the patch opposite to the fastening surface.

Alternatively, the sensor housing may have a threaded recess formed therein and a threaded shaft or stud stands substantially upright from a base plate molded into the patch.

In either case, the part molded into the patch preferably has a polygonal periphery so as to help prevent it rotating relative to the patch as the housing is connected thereto.

Advantageously, the assembly includes an RFID tag or similar by means of which is can be remotely detected and identified. In one embodiment, the RFID tag is integrated into the patch but it may instead be mounted within the housing.

The housing preferably includes at least one antenna which extends therefrom parallel to but spaced apart from the plane of the patch. The patch may then advantageously include an antenna restraint associated with one or more antennas, the one or more antennas' constraint standing substantially upright from the plane of the patch in a direction opposite to said attachment surface and received a part of the antenna in an opening therein so as to maintain its spaced apart relation to the patch. In one embodiment, the housing includes a dipole antenna in the form of two oppositely extending antennas which extend longitudinally along the patch and are supported, proximate to their ends remote from the housing, by an associated antenna constrained which is integrally formed with the patch.

One or more antennas may be dedicated for communication with the sensor within the housing or may perform the dual function of allowing communication with the sensor and also communication with the RFID tag. The latter is particularly advantageous in the embodiment in which the RFID tag is located within the housing as opposed to within the patch.

According to a further aspect of the present invention there is provided a sensor housing having a base which is partially embedded within a patch so as to be secured thereto.

A still further aspect of the present invention provides a sensor housing having fastening means provided thereon by means of which it is attachable to a patch for mounting to an inner wall of a wheel or tire. The attachment means might be adhesive which can be used to stick the housing to the patch, but in one embodiment, is an anchor which engages in an aperture in the patch, and in particular is a threaded, especially a self taping stud which screws into the patch.

### BRIEF DESCRIPTION OF THE DRAWINGS

In order that the invention may be well understood, there will now be described some embodiments thereof, given by way of example, reference being made to the accompanying drawings, in which:

FIG. 1a is a side view of a patch and sensor housing according to a first embodiment of the invention;

FIG. 1b is a top view of the patch and sensor housing of FIG. 1a;

FIG. 2a is a side view of a patch and sensor housing according to a second embodiment of the invention in which an RFID tag is embedded in the patch;

FIG. 2b is a top view of the patch and sensor housing of FIG. 2a;

FIG. 3a is a side view of a patch and sensor housing according to a third embodiment of the invention in which the sensor housing has a dipole antenna;

FIG. 3b is a top view of the patch and sensor housing of FIG. 3a;

FIG. 4a is a side view of a patch and sensor housing according to a fourth embodiment of the invention;

FIG. 4b is a top view of the patch and sensor housing of FIG. 4a;

FIG. 5a is a side view of a patch and sensor housing according to a fifth embodiment of the invention;

FIG. 5b is a top view of the patch and sensor housing of FIG. 5a;

FIG. 6a is a side view of a patch and sensor housing according to a sixth embodiment of the invention;

FIG. 6b is a top view of the patch and sensor housing of FIG. 6a;

### DETAILED DESCRIPTION OF THE PREFERRED EMBODIMENTS

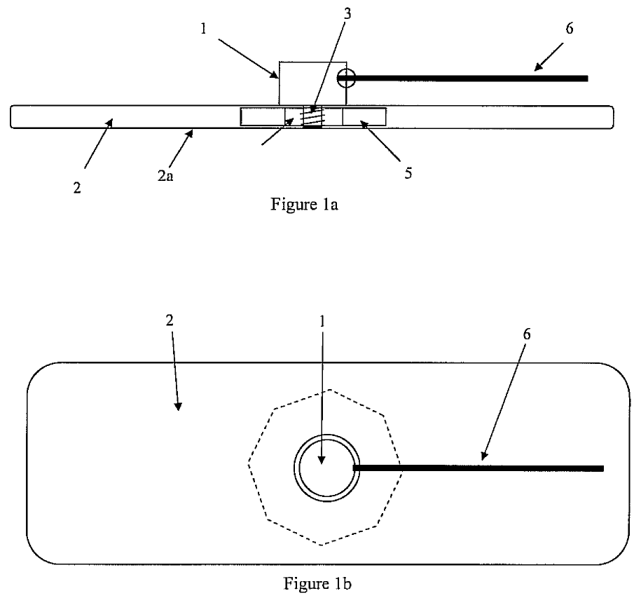

Referring first to FIGS. 1a and 1b, there is shown a sensor housing 1 which is detachably connected to a rubber mounting patch 2. The mounting patch 2 has a lower surface 2a by means of which the patch 2 may be attached to the inside surface of a tire (not shown). The housing 1 houses conventional pressure and temperature sensors such as SAW based sensors which are well known in the art and which not be described further here.

A threaded stud 3 extends from the housing 2 and is engageable with a complementary threaded opening 4 formed in a plate 5 embedded in the patch 2. In this way, the housing may be screwed into the plate 5 so as to secure it to the patch 2. The plate is octagonal so as to anchor it rotationally in the patch although it will be understood that any other polygonal shape would serve this purpose.

An antenna 6 extends from the housing 1 parallel with and spaced apart from the patch and operates to receive and transmit signals for the sensor mounted in the housing, the antenna 6 terminating within the bounds of the patch 2.

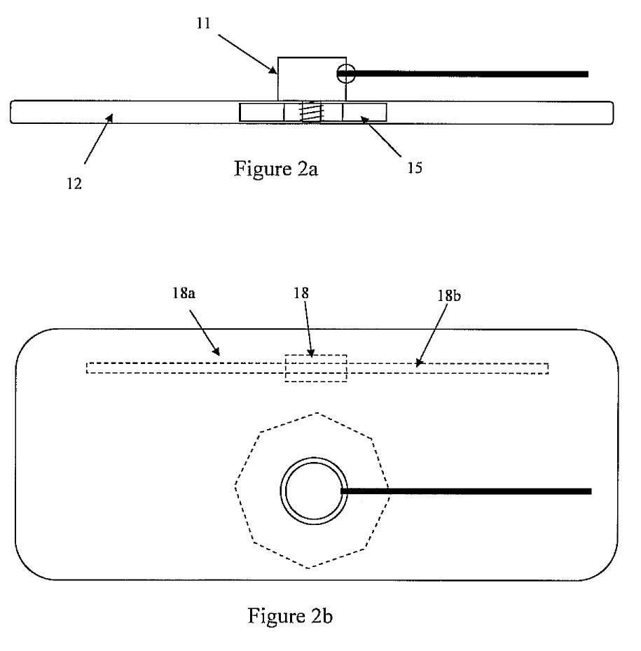

Referring next to FIGS. 2a and 2b, there is shown a second embodiment system identical with the first but having an electronic identification tag in the form of an RFID tag 18 embedded in the patch 12, which tag 18 can be remotely detected and used to identify the patch and hence the sensor attached thereto in the housing 11. The RFID tag 18 includes oppositely extending antennas 18a, 18b also embedded within the patch 12 by means of which communication with the RFID tag is achieved.

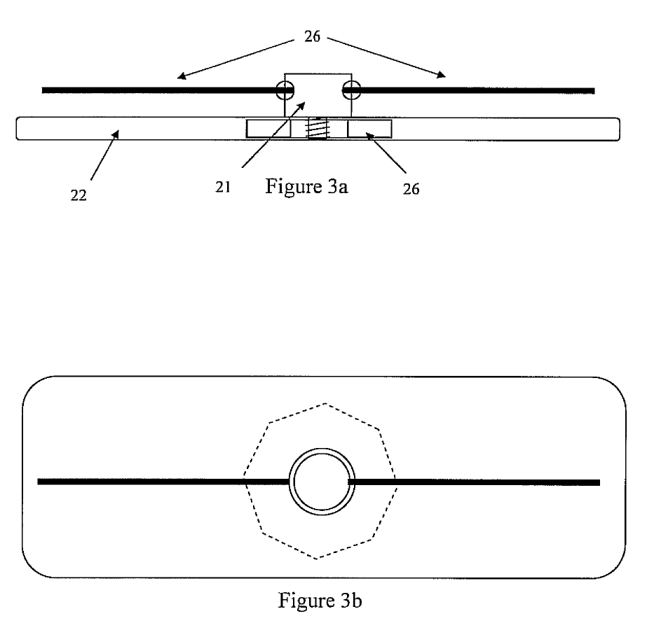

FIGS. 3a, 3b show a third embodiment of the invention identical to the first except that the housing 21 has a dipole antenna 26 which extends in opposing directions from the housing 21 parallel to and spaced apart from the patch 22. As with the first embodiment, both parts of the antenna 26 terminate within the bounds of the patch 22.

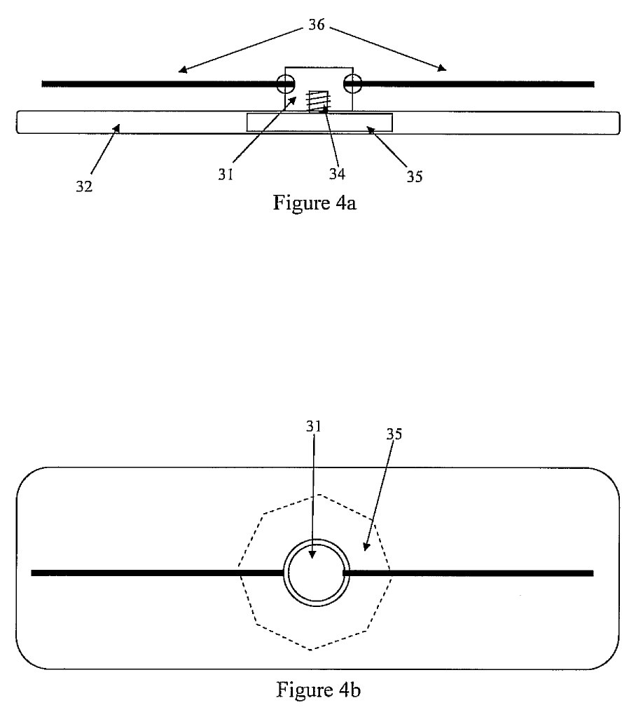

The fourth embodiment, shown in FIGS. 4a and 4b, is similar to that of FIGS. 3a and 3b except that the couple system has been reversed in that the housing 31 has a threaded recess 34 formed therein in and a plate 35 is embedded in the patch 32 which has a threaded stud 36 upstanding therefrom so as to extend from the surface of the patch 32 opposite to the fastening surface. The thread on the stud 36 is complementary to the thread in the recess 34 so that housing may be screwed onto the stud to secure it to the patch.

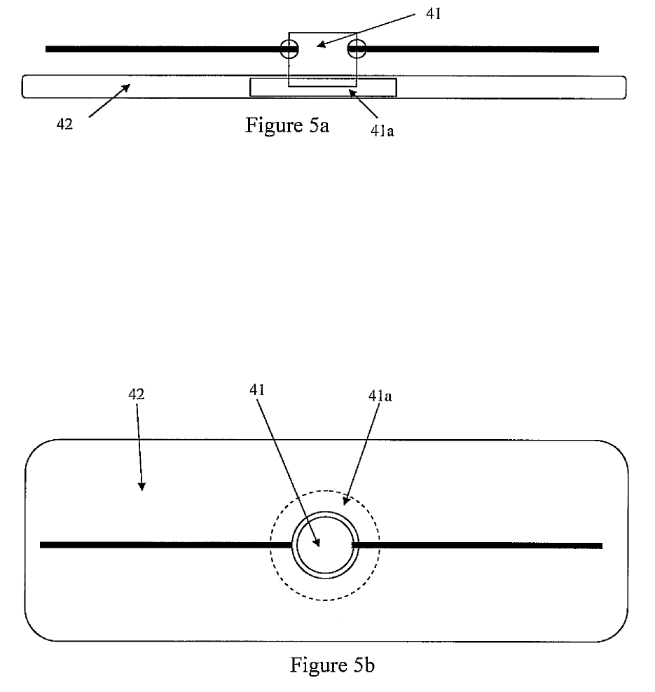

A still further embodiment is shown in FIGS. 5a and 5b in which the housing 41 has a flange 41a on a lower end which is embedded in the patch 42 so as to anchor the housing to the patch.

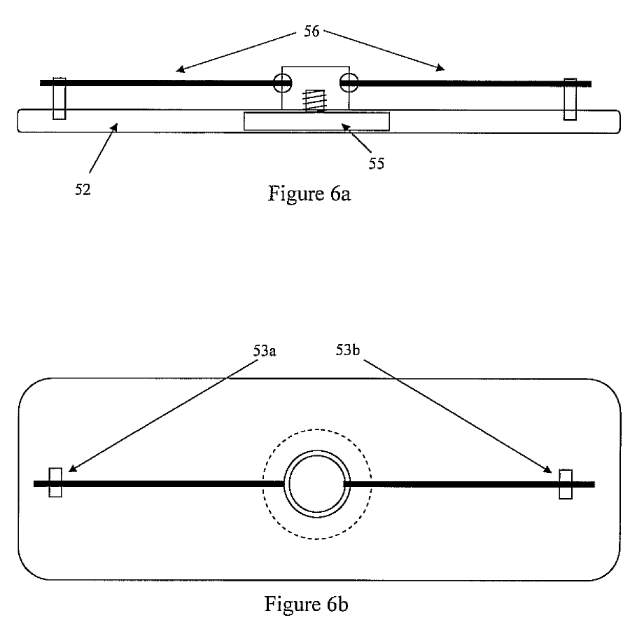

Finally, FIGS. 6a and 6b show a variant of FIG. 4 in which the patch 52 has integrally formed restraints 53a, 53b located at opposing ends for the patch for supporting respective ends of the antennas of the housing so as to maintain their spaced apart relation to the patch and also help to prevent damage thereto.

It will be understood that features of the different embodiments may be combined within the scope of the invention. For example, the embedded RFID tag may be utilized in any of the described embodiment, and equally, the RFID tag may be located within the sensor housing as an alternative. In that instance, the antenna extending from the sensor housing may provide communication for both the sensors housed within the housing as well as for the RFID tag.

Furthermore, the antenna restraints of FIG. 6a may be used in conjunction with any of the described embodiments—in the case of a mono-pole antenna, it will, of course, be understood that only a single such restraint is necessary.

Finally, it will be understood that the threaded coupling may be replaced by other releasable or even non-releasable coupling systems. For example, a bayonet type coupling arrangement may be used or the housing may be stuck directly to the patch using adhesive.

What is claimed is:

1. A sensor mounting assembly for securing a sensor within a pressurized chamber defined between a wheel and a tire, comprising:
a patch having a fastening surface by means in which it is securable, in use, to an inner surface of a tire or wheel; and
a first part of a two part complementary fixing system embedded in the patch, and a sensor housing having a second part of the two part complement fixing system provided thereon, said first and second parts of the complementary fixing system being engageable together in order to secure said housing to the exterior of the patch.

2. A sensor mounting assembly according to claim 1, wherein the two part fixing system comprises a threaded shaft which mates with a complementary threaded recess.

3. A sensor mounting assembly according to claim 2, wherein a plate is embedded in the patch, the plate having a threaded aperture formed therein which formed the threaded recess is in the form of plate.

4. A sensor mounting assembly according to claim 3, wherein the plate is molded as a integral part of the patch.

5. A sensor mounting assembly according to claim 2, wherein the threaded shaft is formed by a projection on the sensor housing and screws into the threaded recess from the side of the patch opposite to the fastening surface.

6. A sensor mounting assembly according to claim 2, wherein the threaded recess if formed in the sensor housing and a threaded shaft stands substantially upright from a plate molded into the patch onto which the sensor housing screws.

7. A sensor mounting assembly according to claim 3, wherein the plate has a polygonal periphery so as to help prevent it rotating relative to the patch.

8. A sensor mounting assembly according to claim 1, wherein the assembly includes an RFID tag or similar by means of which is can be remotely detected and identified.

9. A sensor mounting assembly according to claim 8, wherein the RFID tag is integrated into the patch.

10. A sensor mounting assembly according to claim 8, wherein the RFID tag is mounted within the housing.

11. A sensor mounting assembly according to claim 1, wherein the housing includes at least one antenna which extends therefrom parallel to but space apart from the plane of the patch.

12. A sensor mounting assembly according to claim 11, wherein the patch includes an antenna restraint associated with at least one antenna, the at least one antenna constraint standing substantially upright from the plane of the patch in a direction opposite to said attachment surface and received a part of the antenna in an opening therein so as to maintain its spaced apart relation to the patch.

13. A sensor mounting assembly according to claim 11, wherein the housing includes a dipole antenna in the form of two oppositely extending antennas which extend longitudinally along the patch.

14. A sensor mounting assembly according to claim 13, wherein the end of each antenna which is remote from the housing is supported by an associated antenna constrained which is integrally formed with the patch.
